(19) United States
(12) Patent Application Publication
(10) Pub. No.: US 2007/0091253 A1
(43) Pub. Date: Apr. 26, 2007

(54) Combination of eyeglasses and attachment glasses

(76) Inventor: Kuo-Lung Chao, Taichung County (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/250,453

(22) Filed: Oct. 17, 2005

(51) Int. Cl. G02C 9/02

(52) U.S. Cl. 351/59

(57) ABSTRACT

An eyeglasses combination includes a first pair of glasses having a frame with two rims and a bridge is connected between the two rims. Two lenses are engaged with the two rims and two temples are pivotably connected to two ends of the frame. Two positioning members respectively connected to two temples of the frame and an attachment including at least one rims with a lens is pivotably connected to one of the positioning members by a bolt or a pin so that the attachment is well connected to the first pair of glasses.

### BACKGROUND OF THE INVENTION

1) Field of the Invention

The present invention relates to an eyeglass with positioning members on two temples and an attachment glasses is connected to the positioning members and pivotable relative to the eyeglasses.

2) Description of the Prior Art

A pair of conventional glasses for correcting near-sighted eyes generally includes a frame having two rims with a bridge connected therebetween and two lenses are respectively engaged with the rims. Two temples are pivotably connected to the frame. In order to provide a pair of sunglasses onto the existed glasses, the sunglasses are designed to include a frame with two rims and no temples are needed. The sunglasses include at least one magnet connected thereon and the glasses has another magnet which can be attracted to the at least one magnet on the sunglasses such that the user can easily connect the sunglasses to the glasses. However, the sunglasses can be easily removed from the glasses by any impact and this is because the connection between the magnets is not strong enough to hold the sunglasses in position.

The present invention intends to provide a pair of glasses and at least one rim with a lens are connected to one of the positioning members on the temples of the glasses by a pin so that the at leas tone rim cannot be removed from the glasses easily.

### SUMMARY OF THE INVENTION

The present invention relates to an eyeglasses combination which comprises a pair of glasses having a frame with two rims and a bridge is connected between the two rims. Two respective lenses are engaged with the two rims. Two temples are pivotably connected to two ends of the frame and two positioning members are respectively connected to the frame of the first pair of the glasses. An attachment includes two individual rims and two second lenses are respectively engaged with the two individual rims. Each of the two individual rims has a connection member connected thereto and the connection members of the two individual rims are pivotably connected to the two positioning members.

The primary object of the present invention is to provide a connection between a pair eyeglasses and an attachment which can be another pair of glasses or two individual lenses, the connection is well positioned so that the attachment does not drop by impact or vibration.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a first embodiment of the eyeglasses combination of the present invention;

FIG. 2 shows one of the two individual rims is connected to the frame of the eyeglasses of the present invention;

FIG. 3 is a cross sectional view to show the connection between the positioning member, the connection member and the temple;

FIG. 4 shows a top view of the connection of the positioning member, the connection member and the temple;

FIG. 5 shows that the individual rim is pivoted away from the frame;

FIG. 6 shows two decoration totems are pivotably connected to the two connection members;

FIG. 7 is an exploded view to show a second embodiment of the combination of the present invention;

FIG. 8 is a cross sectional view to show the insertion inserted into the recess in the connection member in FIG. 7;

FIG. 9 shows a top view of the connection of the positioning member, the connection member and the temple in FIG. 7;

FIG. 10 shows a third embodiment of the combination of the present invention;

FIG. 11 is an exploded view to show a fourth embodiment of the combination of the present invention;

FIG. 12 is a perspective view to show the fourth embodiment of the combination of the present invention, and

FIG. 13 is an exploded view to show a fifth embodiment of the combination of the present invention.

### DETAILED DESCRIPTION OF THE PREFERRED EMBODIMENT

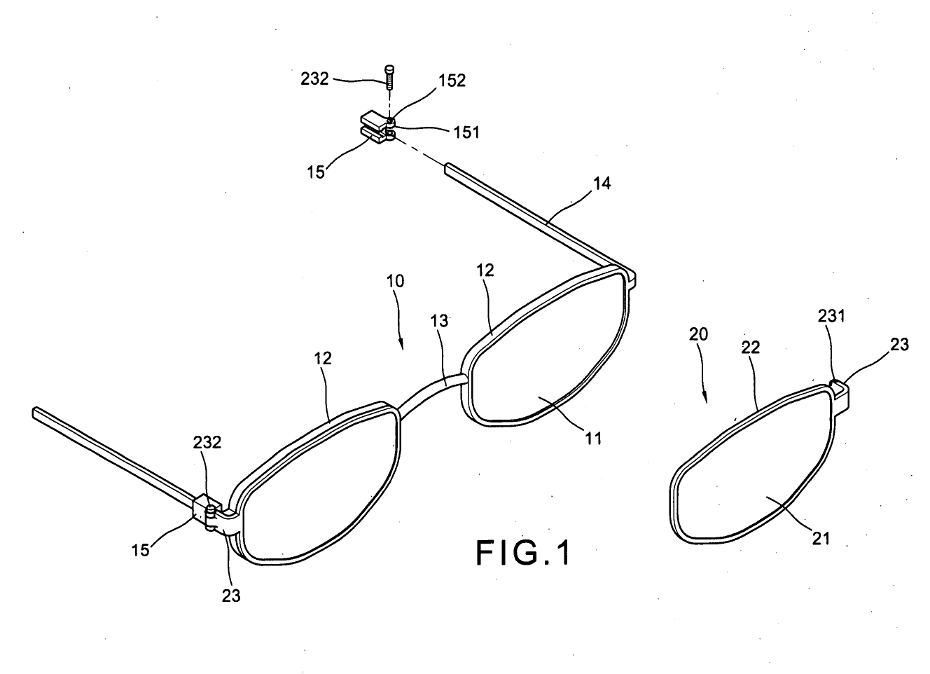

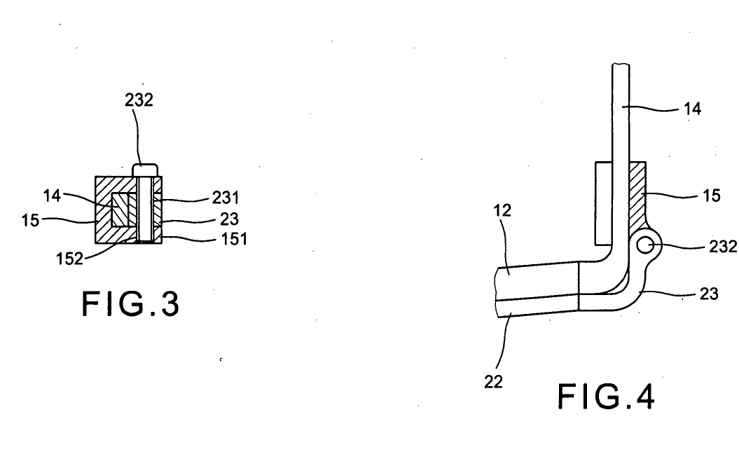

Referring to FIGS. 1 to 5, the eyeglasses combination of the present invention comprises a first pair of glasses 10 having a frame with two rims 12 and a bridge 13 connected between the two rims 12. Two lenses 11 are engaged with the two rims 12 and two temples 14 are pivotably connected to two ends of the frame. Two positioning members 15 are respectively connected to the frame of the first pair of the glasses 10 and each of the positioning members 15 has a U-shaped cross section so that the two temples 14 of the first pair of glasses 10 are respectively engaged with the positioning members 15. Each of the positioning members 15 further has two first lugs 151 and each first lug 151 has a first hole 152.

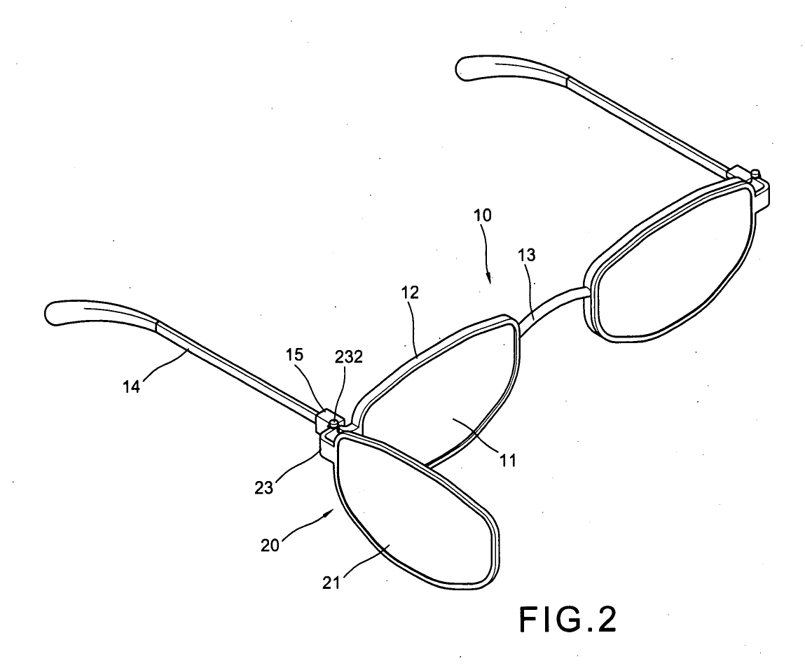

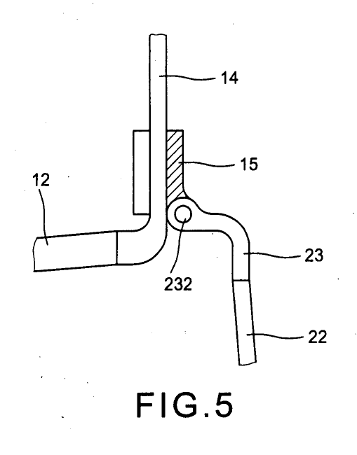

An attachment 20 includes two individual rims 22 and two second lens 21 are respectively engaged with the two individual rims 22. Each of the two individual rims 22 has a connection member 23 integrally connected thereto and the connection members 23 of the two individual rims 22 pivotably connected to the two positioning members 15. The connection members 23 each have a through hole 231 and two bolts 232 extend through the aligned first holes and the through holes 231 so that the two individual rims 22 with the second lenses 21 can be pivoted about the bolts 232 as shown in FIGS. 2 and 5. Because the two individual rims 22 with the second lenses 21 are pivotably connected to the positioning members 15 by bolts 232 so that they are well positioned and do not drop from the first pair of glasses 10.

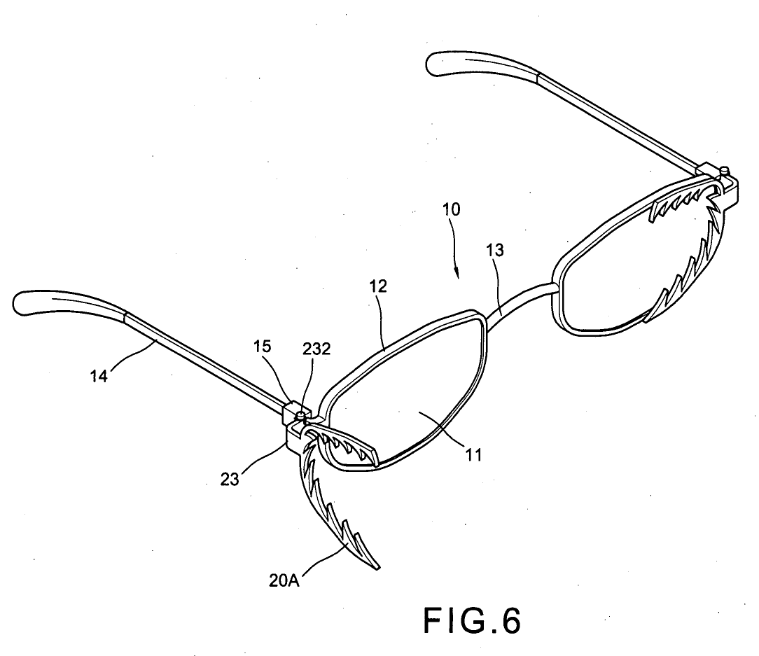

As shown in FIG. 6, the individual rims 22 can be replaced with two decoration totems 20A which can be a C-shaped decoration member and can matched with the shape of the rims 12.

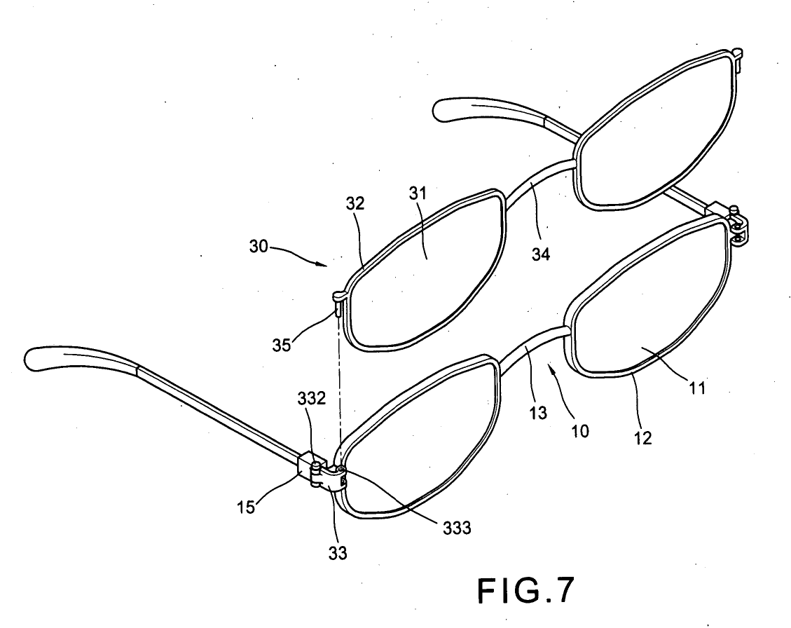

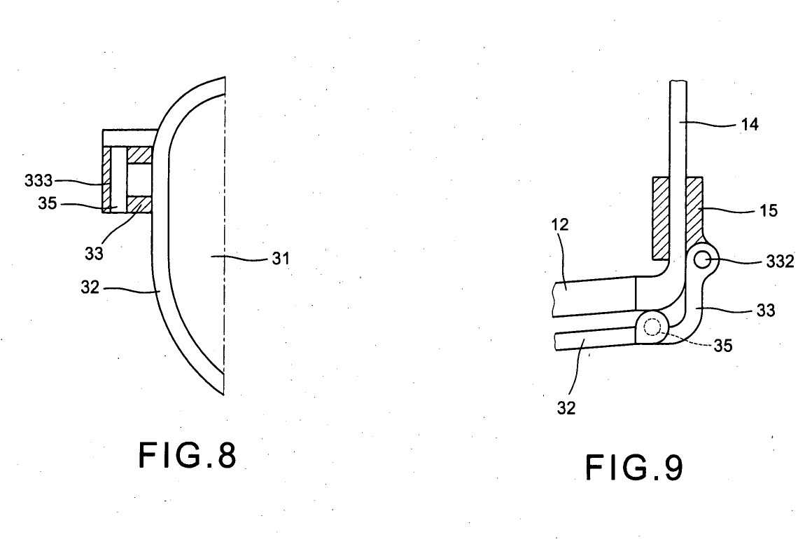

FIGS. 7 to 9 show a second embodiment of the present invention, wherein the first pair of glasses 10 has a frame with two rims 12 and a bridge 13 is connected between the two rims 12. Two lenses 11 are engaged with the two rims 12 and two temples 14 are pivotably connected to two ends of the frame. Two U-shaped positioning members 15 are respectively connected to the temples 14 of the frame of the first pair of the glasses 10 and two connection members 33 are pivotably connected to the two positioning members 15 by two respective bolts 332. The two connection members 33 each having a recess 333 defined in the other end opposite to the end with the bolts 332 extending therethrough.

An attachment 30 includes a frame with two rims 32 and a bridge 34 is connected between the two rims 32. Two second lenses 31 are respectively engaged with the two rims 32 and two insertions 35 extend from the frame and are pivotably inserted into the recesses 333 in the two connection members 33. The insertions 35 and an inner periphery of each of the recesses 333 are made by magnetic material so that the user can easily insert the insertions 35 into the recesses 333 by the attraction force.

It is noted that the recesses 333 of the two connection members 33 are perpendicular to axes of the two temples 14, and the two insertions 35 are located such that the insertions 35 are inserted into the recesses 333 from above of the connection members 33.

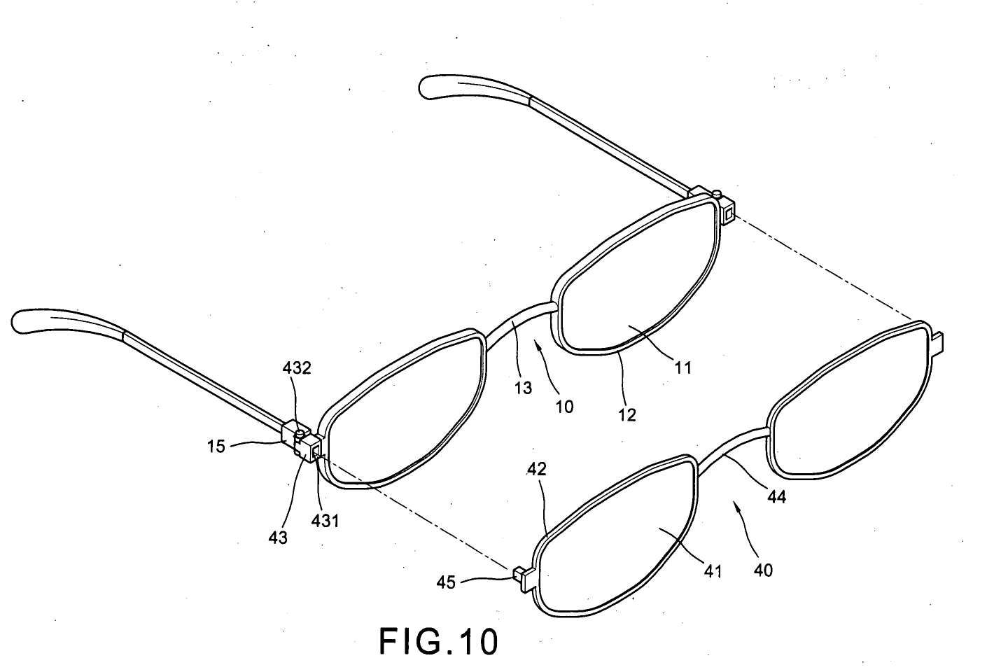

As shown in FIG. 10 which shows a third embodiment of the present invention, wherein the structure of the third embodiment is very similar to the second embodiment, only the positions of the recesses are different. The recesses 431 of the two connection members 43 on the two temples 14 are parallel to axes of the two temples 14, and the attachment 40 includes two rims 42 with two second lenses 41 engaged therewith and a bridge 44 is connected between the two rims 42. Two insertions 45 on the attachment 40 are located such that the insertions 45 are inserted into the recesses 431 from front of the frame.

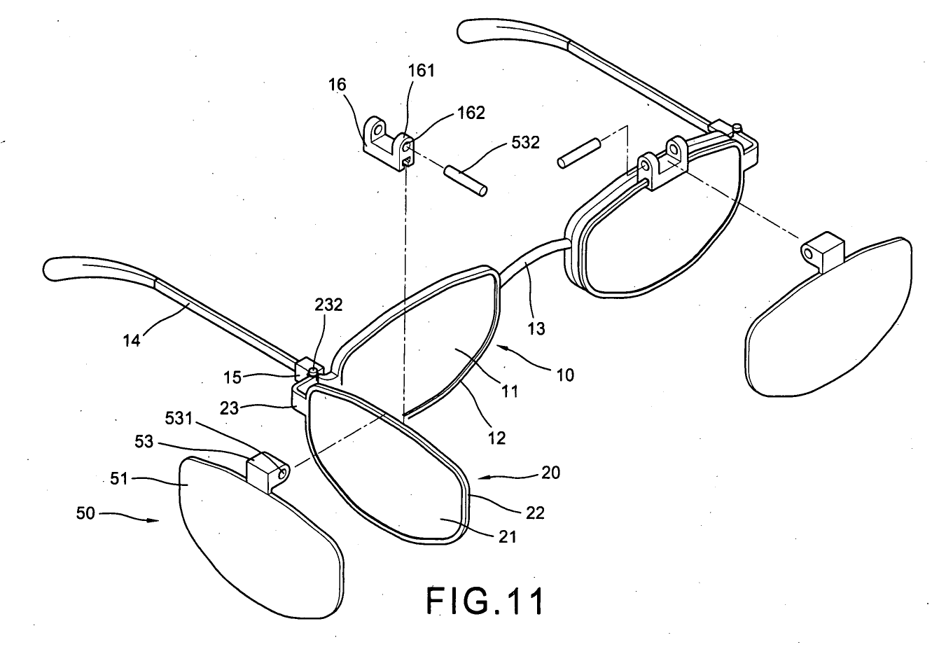

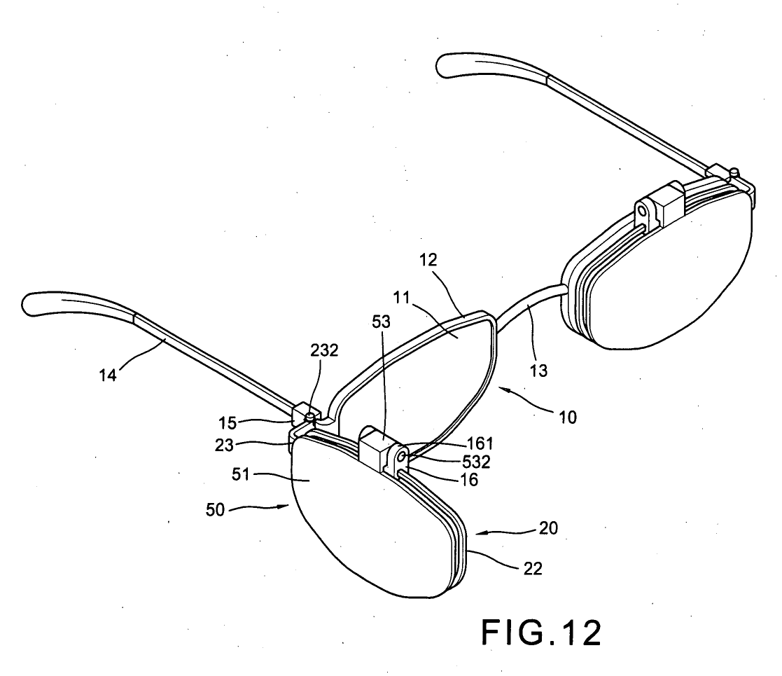

FIGS. 11 and 12 show a fourth embodiment of the present invention wherein the first pair of glasses 10 has a frame with two rims 12 and a bridge 13 is connected between the two rims 12. Two lenses 11 are engaged with the two rims 12 and two temples 14 are pivotably connected to two ends of the frame.

Two positioning members 15 are respectively connected to the two temples 14 of the frame of the first pair of the glasses 10 and two connection members 33 are pivotably connected to the two positioning members 15 by two bolts 232. The two connection members 33 are integrally connected to two individual rims 22 of an attachment 20. Each of the two individual rims 22 has a second lens 21 engaged therewith. Two second positioning members 16 are connected to a top edge of the two individual rims 22 and each of the second positioning members 16 includes two lugs 161 and each lug 161 has a hole 162.

A second attachment 50 includes two individual lenses 51 and each of the two individual lenses 51 has an engaging member 53 through which a through hole 531 is defined. The two engaging members 53 of the two individual lenses 51 are pivotably connected to the two lugs 161 of the two second positioning members 16 by two pins 532. Therefore, the rims 22 can be pivoted about the bolts 232 outward and the lenses 51 can be pivoted about the pins 532 upward.

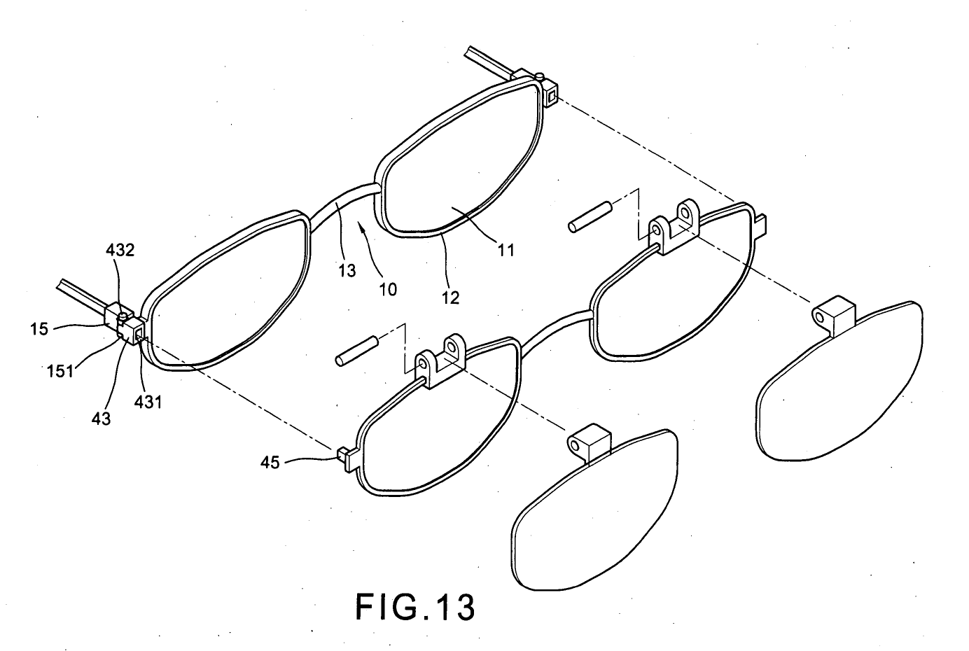

FIG. 13 shows a fifth embodiment of the present invention wherein the first pair of glasses 10 has a frame with two rims 12 and a bridge 13 is connected between the two rims 12. Two temples 14 are pivotably connected to two ends of the frame. Two positioning members 15 are respectively connected to the two temples 14 of the frame of the first pair of the glasses 10 and two connection members 43 are pivotably connected to two lugs 151 of the two positioning members 15 by two bolts 432. The two connection members 43 each have a recess 431 defined in a front end thereof. The recesses 431 of the two connection members 43 are parallel to axes of the two temples 14.

An attachment 40 includes a second frame with two rims 42 and two insertions 45 extend from the second frame. The two insertions 45 are located such that the insertions 45 are inserted into the recesses 431 from front of the frame.

Two second positioning members 60 are respectively connected to two respective top edges of the two rims 42 and each second positioning member 60 includes two lugs and each lug has a hole 61. Two individual lenses 70 each have an engaging member 71 and the two engaging members 71 of the two individual lenses 70 pivotably connected to the two second positioning members 60 by extending two pins 62 through the holes 61 in the lugs of the second positioning members 60 and the through holes 72 in the two engaging members 71.

While we have shown and described the embodiment in accordance with the present invention, it should be clear to those skilled in the art that further embodiments may be made without departing from the scope of the present invention.

What is claimed is:

1. An eyeglasses combination comprising:
a first pair of glasses having a frame with two rims and a bridge connected between the two rims, two lenses engaged with the two rims and two temples pivotably connected to two ends of the frame;
two positioning members respectively connected to the frame of the first pair of the glasses;
an attachment including two individual rims and two second lens respectively engaged with the two individual rims, each of the two individual rims having a connection member connected thereto, the connection members of the two individual rims pivotably connected to the two positioning members.

2. The combination as claimed in claim 1, wherein the positioning members each have a U-shaped cross section and the two temples of the first pair of glasses are respectively engaged with the positioning members.

3. The combination as claimed in claim 1, wherein each of the positioning members has two first lugs and each first lug has a first hole, the connection members each have a through hole, two bolts extend through the aligned first holes and the through holes.

4. The combination as claimed in claim 1, wherein the connection members are integrally connected to the two individual rims.

5. The combination as claimed in claim 1, wherein two second positioning members are respectively connected to the two individual rims and the two individual lenses each have an engaging member and the two engaging members of the two individual lenses are pivotably connected to the two second positioning members.

6. The combination as claimed in claim 5, wherein each of the second positioning members includes two lugs and each lug has a hole, the engaging members each have a through hole so that the engaging members are pivotably connected to the second positioning members by extending two pins through the through holes of the engaging members and the holes in the second positioning members.

7. The combination as claimed in claim 5, wherein second positioning members are respectively connected to two respective top edges of the two individual rims.

8. An eyeglasses combination comprising:
a first pair of glasses having a frame with two rims and a bridge connected between the two rims, two lenses engaged with the two rims and two temples pivotably connected to two ends of the frame;
two positioning members respectively connected to the frame of the first pair of the glasses and two connection members pivotably connected to the two positioning members, the two connection members each having a recess;
an attachment including a frame with two rims and a bridge connected between the two rims, two second lens respectively engaged with the two rims, two insertions extending from the frame and pivotably inserted into the recesses in the two connection members.

9. The combination as claimed in claim 8, wherein the insertions and an inner periphery of each of the recesses are made by magnetic material.

10. The combination as claimed in claim 8, wherein the positioning members each have a U-shaped cross section and the two temples of the first pair of glasses are respectively engaged with the positioning members.

11. The combination as claimed in claim 8, wherein the recesses of the two connection members are perpendicular to axes of the two temples, the two insertions are located such that the insertions are inserted into the recesses from above of the connection members.

12. The combination as claimed in claim 8, wherein the recesses of the two connection members are parallel to axes of the two temples, the two insertions are located such that the insertions are inserted into the recesses from front of the frame.

13. An eyeglasses combination comprising:
a first pair of glasses having a frame with two rims and a bridge connected between the two rims, two lenses engaged with the two rims and two temples pivotably connected to two ends of the frame;
two positioning members respectively connected to the frame of the first pair of the glasses and two connection members pivotably connected to the two positioning members, the two connection members each having a recess;
an attachment including a second frame with two rims and two insertions extending from the second frame, the two insertions being inserted into the two recesses of the connection members, two second positioning members respectively connected to the two rims, and
two individual lenses each having an engaging member and the two engaging members of the two individual lenses pivotably connected to the two second positioning members.

14. The combination as claimed in claim 13, wherein the recesses of the two connection members are parallel to axes of the two temples, the two insertions are located such that the insertions are inserted into the recesses from front of the frame.
